(19) United States
(12) Patent Application Publication
(10) Pub. No.: US 2017/0232732 A1
(43) Pub. Date: Aug. 17, 2017

(54) SYSTEMS AND METHODS TO ACTIVATE PRINT ELEMENTS OF PRINT HEADS IN AN INK PRINTING APPARATUS

(71) Applicant: Océ Holding B.V., Venlo (NL)

(72) Inventor: Roland Wolf, Unterhaching (DE)

(73) Assignee: Océ Holding B.V., Venlo (NL)

(21) Appl. No.: 15/433,066

(22) Filed: Feb. 15, 2017

(30) Foreign Application Priority Data
Feb. 16, 2016 (DE) 10 2016 102 683.2

(51) Int. Cl. B41J 2/045

(52) U.S. Cl. CPC B41J 2/04508; B41J 2/04586

(57) ABSTRACT

In a method for printing, print images can be stored in the printer controller as bitmaps made up of bitmap data arranged in rows and columns. A printing element of a print head may be associated with a respective column of the bitmap. The same bitmap data of the bitmap may be associated with the printing elements of the print heads that are situated in an overlap region. The printing elements in the overlap region can be activated such that a print dot associated with a bitmap datum may be printed both by a printing element of the one print head and by a printing element of the other print head.

### CROSS REFERENCE TO RELATED APPLICATIONS

This patent application claims priority to German Patent Application No. 102016102683.2, filed Feb. 16, 2016, which is incorporated herein by reference in its entirety.

### BACKGROUND

Ink printing apparatuses may be used for single-color or multicolor printing to a printing substrate, for example a single sheet or a belt-shaped printing substrate made of the most varied materials, for example a paper web. An example design of such ink printing apparatuses is illustrated in EP 0 788 882 B1. Ink printing apparatuses that, for example, operate according to the Drop-on-Demand (DoD) principle have as a printing unit, a print head, or multiple print heads with nozzles comprising ink channels, the activators of which nozzles—controlled by a printer controller—excite ink drops in the direction of a printing substrate. The ink drops are directed onto the printing substrate to apply print dots there for a print image. The activators may generate ink drops thermally (bubble jet) or piezoelectrically.

The design of a print head that has (for example) printing elements with piezoelectric activators is illustrated in U.S. Pat. No. 7,281,778 B2. A printing element comprises an ink channel that ends in a nozzle arranged in a nozzle plate, and provides an activator that is arranged at the ink channel. The printing substrate web is directed past the nozzle plate. If printing should occur, the activators provided for the printing are activated by a printer controller, which activators thereupon subject the ink in the ink channels to pressure waves via which the ejection of ink drops from the nozzles in the direction of the printing substrate web is induced.

In an ink printing system, the ink print heads of one color are arranged next to one another and offset from one another in a print bar to achieve a greater print width or a higher print resolution or print speed. It is possible to mechanically align the print heads within a print bar relative to one another, or to electronically adjust the point in time of printing of the nozzles of the print heads so that the print dots on the printing substrate strike the desired location predetermined by the print controller.

Given the arrangement of the print heads relative to one another on the print bar, it is thereby to be considered that no gaps may be created in the print image during printing. In order to achieve this goal, the print heads can be arranged offset from one another such that nozzles from two adjoining print heads are located in an overlap region. Such an arrangement of two print heads is illustrated in DE 10 2010 036 957 A1. Within a print head, the nozzles are arranged in rows, wherein the nozzles of adjacently situated rows are situated offset relative to one another, such that the nozzles are arranged immediately adjacent to one another given a projection of the nozzles in the transport direction of the printing substrate. The nozzles of the rows of a print head are then respectively situated on diagonals.

In EP 1 375 146 A1, it is described that—given an ink printing apparatus having print heads arranged offset and angled relative to one another—printing elements of both print heads are arranged in an overlap region of two respective print heads. In the printing operation, it should then be avoided that troublesome streaks are created due to activation of printing elements in the overlap regions. In order to deal with this problem, three solutions are examined:
the first solution path, the printing elements of both print heads print in the overlap region: this procedure leads to the situation that the print image is intensified in the overlap region. This mode of operation is applied given laminar print images.
In the second solution path, the printing elements of the two print heads fire in alternation in the overlap region. This mode of operation leads to an irregular print image in the overlap region.
In the third solution path, the printing elements of one of the print heads fire in the overlap region of the two print heads. This mode of operation is considered to be advantageous given printing of lines.

Corresponding to offset printing, in digital printing the print images may be presented in a pixel raster according to one or more rasterizing methods. In the print controller, a bitmap made up of bitmap data (which indicate whether a “1” for the generation of a print dot on the printing substrate or a “0” for no print dot is to be associated with the individual pixel in the pixel raster) corresponds to the pixel raster. The print images are then stored as bitmaps in the print controller, wherein the individual bitmap data (also called print data) specify whether the printing element associated with this bitmap datum fires an ink drop or not. The greyscale value or tone value of such a rasterized print image is defined by the ratio of the PELs (printed elements) that exhibit print dots to the PELs that exhibit no print dots.

High-capacity printing systems are thus comprised of an arrangement of multiple print heads arranged offset from one another. This enables a seamless printing beyond the boundaries of the print heads in multiples of the width of the print heads. In the print controller, the print data prepared in the bitmaps are associated with the printing elements in a defined coordinate system and printed line by line. The exact adjustment of the print heads relative to one another is hereby technically complicated since deviations on the order of 10 μm may already lead to visible streak formations in uniformly inked surfaces.

While the adjustment in the printing direction may still be compensated electronically via adaptation of the timing in the drop formation, the adjustment transversal to the printing direction has previously only been achieved via mechanical adjustment. This requires high-precision mechanical elements as well as a time-consuming adjustment process in the installation and given exchange of individual print heads.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1 illustrates a print head arrangement having multiple print bars, in an ink printing unit, according to an exemplary embodiment of the present disclosure.

FIG. 2 illustrates a print head bar including five print heads situated offset from one another according to an exemplary embodiment of the present disclosure.

FIG. 3 illustrates a partial plan view of nozzle plates of two adjacently arranged print heads, with indication of the overlap region, according to an exemplary embodiment of the present disclosure.

FIGS. 4a-4g illustrate operations for compensation of superposition effects given adjacently arranged print heads according to an exemplary embodiment of the present disclosure.

FIG. 5 illustrates a workflow diagram of the method according to the operations shown in FIGS. 4a-4g.

The exemplary embodiments of the present disclosure will be described with reference to the accompanying drawings.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring embodiments of the disclosure.

Embodiments of the present disclosure solve the problems arising in the related art, and can include a method for operating print heads within a print head arrangement in an ink printing apparatus. The print head arrangement can have multiple print heads offset and overlapping relative to one another. In one or more embodiments, superposition effects of adjacently situated print heads may be minimized in the overlap region.

Using a correction method in the raster processing into print data according to one or more exemplary embodiments, mechanical adjustment operations for overlapping print heads can be replaced by a locally limited correction in the bitmap data for these print heads. The print heads may then be mechanically installed on the print bar tightly relative to one another and with a defined overlap region relative to one another.

In an exemplary embodiment, the print images are stored in the printer controller as bitmaps made up of bitmap data arranged in rows and columns, wherein a printing element of a print head may be associated with a respective column. The same bitmap data of the bitmap may be associated with the printing elements of the print heads that are situated in the overlap region, wherein the printing elements in the overlap region may be activated such that a print dot associated with a bit datum may be printed by both a printing element of the one print head and by a printing element of the other print head.

In an exemplary embodiment, the associated columns of the bitmap of the print image are duplicated based on the number of printing elements in the overlap region, such that the individual printing elements in the overlap region are mapped by their own bitmap columns. The pixels to be printed in the overlap region may now be printed alternately by one of the two overlapping print heads.

In an exemplary embodiment, possible Moiré effects in the print image that might occur given the alternating association of the bitmap data with print heads may be prevented via use of a random number generator.

In one or more exemplary embodiments, more complex rasterizing algorithms can be employed that associate the pixel with either the one or the other print head depending on the surrounding pixel data. For example, the rasterizing algorithm may decide that the printing elements of that print head that prints the remaining part of the print image print in the overlap region.

Since the tone value increase in print images is non-linear, an offset of print dots printed in the overlap region by the printing elements of the print heads may still lead to visible transitions in the sub-pixel range. To compensate for this, in an exemplary embodiment, a tone value curve measured at a reference print sample may be determined in the overlap region. The distribution of the pixels to the two print heads may then be specifically corrected using a correction function developed from the tone value curve, which correction function includes the sub-pixel pitch as an input variable. In an exemplary embodiment, to achieve a somewhat darker inking overall in the overlap region, a proportion of the pixels to be printed may be printed by both print heads simultaneously, corresponding to the correction function.

Methods according to embodiments of the present disclosure have the following advantages:

A compensation of defects in the print image in the overlapping print region of two adjacently arranged print heads is enabled via distribution of the pixels to be printed to the two print heads. For example, given overlapping nozzles of the printing elements of the print heads, the printing element of the one or the other print head may alternately generate a print dot on the printing substrate.

Furthermore, a distribution of the pixels to be printed to the printing elements of the two print heads is possible with the aid of a random number generator.

Additional correction algorithms may detect the pitch of the print dots in the sub-pixel range and influence the pixel raster generation via compensation curves.

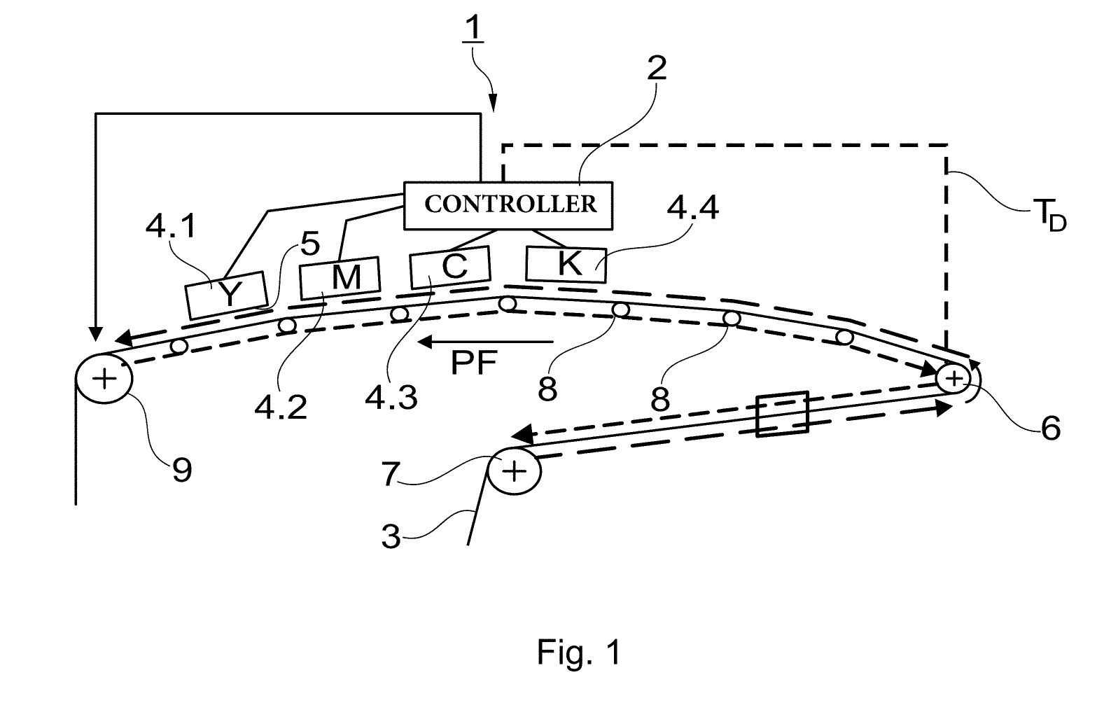

An ink printing apparatus according to an exemplary embodiment of the present disclosure is illustrated in FIG. 1. In an exemplary embodiment, an ink printer 1 for printing to a printing substrate 3 can include a transport unit for the printing substrate 3 and a printer controller 2. Arranged along the printing substrate 3 are print bars 4 with print heads 5 one after another as viewed in the transport direction PF of the printing substrate 3. Given color printing, for example, a respective print bar 4 may be provided per color to be printed. The printing substrate 3 is moved past the print bars 4 with the aid of drive rollers 7, 9; it thereby rests on a roll saddle 8 with guide rollers. A sensor 6 can be configured to generate print clock pulses T_{D} based on the feed movement of the printing substrate 3. The sensor 6 may be arranged at the input of the print bar unit DE. The sensor 6 can be configured to supply the print clock pulses T_{D} to the printer controller 2. The printer controller 2 can be configured to, based on the print clock pulses T_{D}, establish the point in time of the ejection of ink drops at the nozzles of the individual print heads 5 if print data for printing are already present in the printer controller 2. In an exemplary embodiment, the printer controller 2 can include processor circuitry configured to perform one or more functions and/or operations of the printer controller 2. The sensor 6 may be, for example, a rotary encoder or encoder drum 6 that is driven by the printing substrate 3, but is not limited thereto. The sensor 6 may include processor circuitry configured to perform one or more functions and/or operations of the sensor 6.

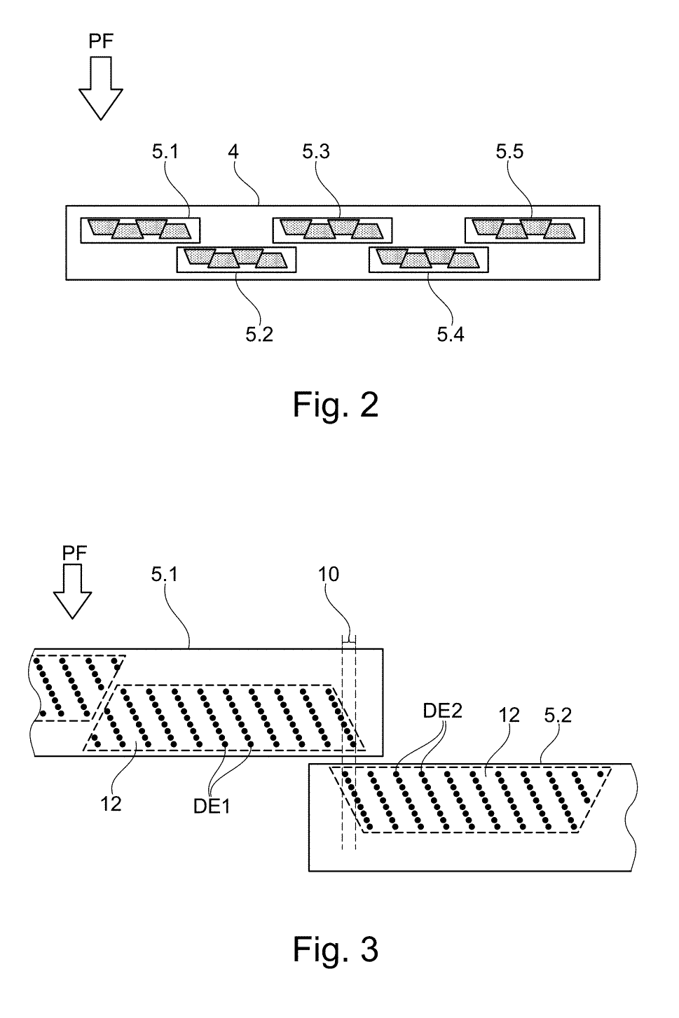

FIG. 2 illustrated print bar 4 according to an exemplary embodiment of the present disclosure. In an exemplary embodiment, print bar 4 includes, for example, five print heads 5.1 through 5.5, but is not limited thereto and can include more or fewer print heads. In an exemplary embodiment, the print heads 5 within print bar 4 are arranged offset relative to one another in two rows, for example. FIG. 3 illustrates an exemplary arrangement of the print heads 5, including the overlap region 10 of two adjacently situated print heads 5.1 and 5.2 in a plan view on the respective nozzle side 12 of the print heads 5.1 and 5.2. The ends of the printing elements DE are indicated by dots. The travel direction of the printing substrate 3 (not shown) is indicated by the arrow PF. Arranged in the overlap region 10 of two adjacently situated print heads 5 (for example the print heads 5.1 and 5.2) are printing elements DE1 of the print head 5.1 and printing elements DE2 of the print head 5.2. The printing elements DE1, DE2 of both print heads 5.1, 5.2 may thus generate print dots on the printing substrate 4 in the overlap region 10. Exemplary embodiments of the present disclosure reduce or avoid streaks or streaking upon printing that may be caused by the overlapping configuration.

Methods according to exemplary embodiment can reduce or avoid streaks within the print image that may be generated on the printing substrate 4. In an exemplary embodiment, it is assumed that an overlap region 10 of four respective printing elements DE1, DE2 are provided in the print heads 5.1, 5.2, but the disclosure is not limited thereto. More or fewer overlapping printing elements can be realized in other embodiments. In an exemplary embodiment, the overlap region 10 is larger than the maximum sum of the mechanical tolerances in the chain of the mechanical elements (manufacturing precision of the nozzles, precision of the bearing points, manufacturing precision in the support frame). For example, a nominal overlap region 10 of 4 pixels may be provided for print heads 5 with a physical resolution of 1200 dpi (corresponds to a nominal nozzle pitch of approximately 21 μm) and a sum tolerance of 80 μm. The width of the bitmap to be printed is reduced corresponding to the number of upper limits. In an exemplary embodiment, the resulting print width is determined based on the following:

number of physical pixels to be printed: x=a*m

maximum print width in pixels: x′=x−(m−1)*b,

where:

a is the number of nozzles of a print head

b is the nominal overlap in pixels

m is the number of print heads across the print width.

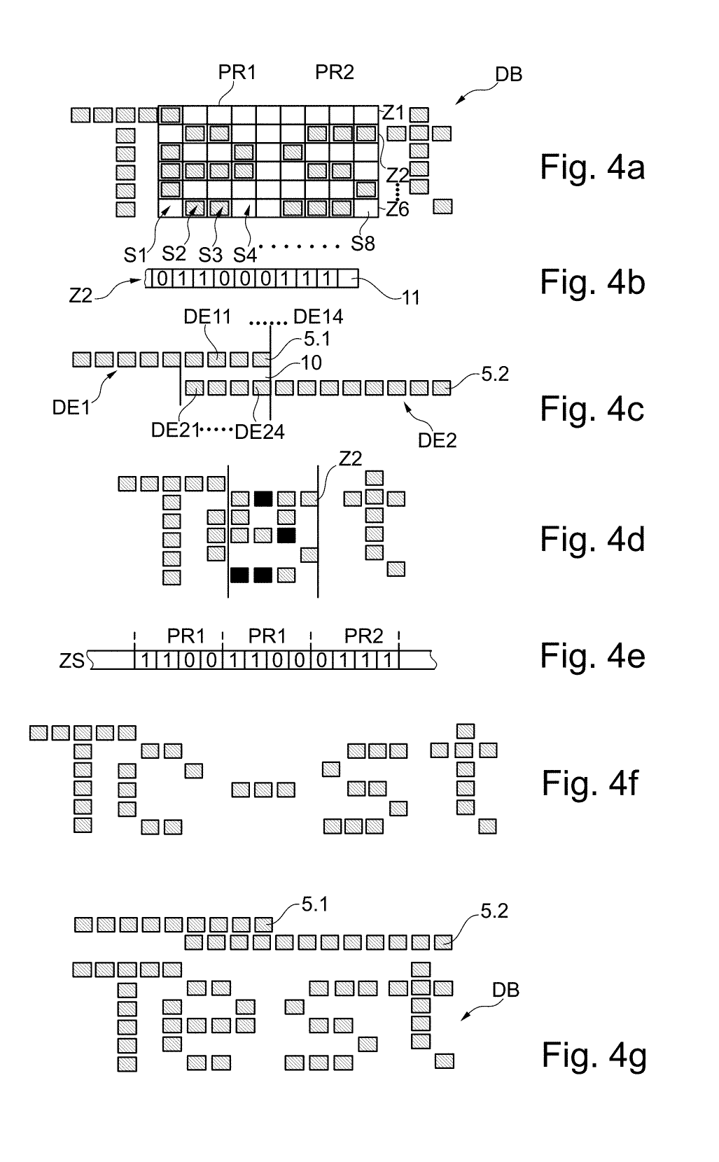

FIGS. 4a-4g illustrate the workflow of the generation of bitmap data or print data for a print image DB according to an exemplary embodiment of the present disclosure. The individual steps are thereby shown aligned one below another.

The print image DB according to an exemplary embodiment is shown in FIG. 4a, and includes the word “Test”. For the print image DB, a pixel raster PR is generated according to a known rasterizing method, from which pixel raster PR a digital bitmap is generated from bitmap data arranged in bitmap data rows Z and bitmap data columns S, wherein the bitmap data indicate whether print dots should be generated on the printing substrate 4 at the location of the pixel. A pixel is then indicated as a blackened square if a print dot should be generated at its location.

In FIG. 4a, a pixel raster PR1 has been generated over the letter “e” and a pixel raster PR2 has been generated over the letter “s”, which pixel raster PR1, PR2 should consist of four columns S1 through S4 and six rows Z1 through Z6. Bitmaps are generated corresponding to the pixel rasters PR1, PR2, the bitmap data of which include a “1” for the character “e” and the character “s” if a print dot should be generated at the printing substrate 4 at their location; otherwise, said bitmap data include a “0”. In an exemplary embodiment, the printer controller 2 is configured to generate the bitmaps. The printing elements DE of the print heads 5 are thus activated corresponding to the bitmaps. The printer controller 2 can be configured to activate printing elements DE of the print heads 5 based on the bitmaps.

A print register 11 according to an exemplary embodiment is shown in FIG. 4b. In print register 11, the individual bitmap data are entered for the row Z2 of the pixel rasters PR1, PE2, and for the pixel raster columns S1 through S8. Furthermore, the overlap region 10 of two adjacently situated print heads 5.1, 5.2 are depicted below the print register 11 in FIG. 4c, and in fact the printing elements DE11 through DE14 of the print head 5.1 and the printing elements DE21 through DE24 of the print head 5.2 in the overlap region 10. If the printing elements DE11 through DE24 are activated corresponding to the bitmap data of the print register 11, a respective print dot is generated in the overlap region 10 by the respective printing elements DE of the print head 5.1 in the row Z2 in the columns S1 and S2, and a respective print dot is printed by the respective printing elements DE of the print head 5.2 in the columns S2, S3, S4. The result of the printing in FIG. 4d shows that the character “s” has been printed over the character “e”.

In an exemplary embodiment, the bitmap for the character “e” in the overlap region 10 per row Z is duplicated. For the row Z2, the result is shown in the print register 11 in FIG. 4e. If the printing elements DE11 through DE14 and DE21 through DE24 are now activated via the print register 11, the printing elements DE11 through DE14 or the printing elements DE21 through DE24 may selectively print the print dots corresponding to the row Z2 of the pixel raster PR.

For example, in the example of FIG. 4e the rows Z2, Z3, Z6 are printed by the printing elements DE1 of the print head 5.1, and the row Z4 is printed by the printing elements DE2 of the print head 5.2 (FIG. 4f). Since these printing elements DE are situated in the overlap region 10, the rows Z1 through Z6 of the pixel raster PB1 may be selectively printed either by the printing elements DE1 of the print head 5.1 or by the printing elements DE2 of the print head 5.2 (FIG. 4f).

FIG. 4g shows the print result. An overprinting of two different characters in the overlap region 10 is avoided.

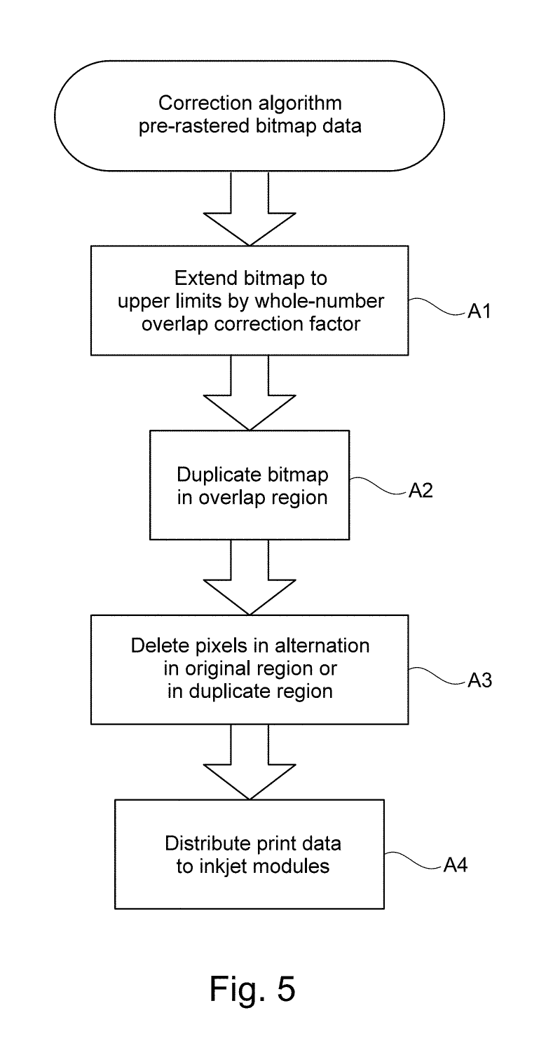

FIG. 5 shows a compensation method according to an exemplary embodiment of the present disclosure.

In preparation, the overlap region 10 of adjacently situated print heads 5—which may comprise four printing elements DE per print head 5, for example (FIG. 3)—is established. The overlap region 10 may be predetermined by the design arrangement of the print heads 5.

In an additional preparatory step, the print image is then rasterized and a pixel raster made up of raster columns and raster lines is then generated from which a bitmap is developed, such that bitmap data are associated with the printing elements DE of a print head 5. From the bitmap, it results per printing element DE whether this should fire a print dot onto the printing substrate 4 or not. The bitmap is stored in the printer controller 2, for example, in a memory of the printer controller 2 and/or in an external memory. It can then be determined, from the bitmap, at which locations on the printing substrate 5 print dots should be generated. The rows Z of the bitmap are stored in a print register 11, for example, wherein a register location is associated with a printing element DE. This association also applies to the printing elements DE of the print heads 5 that are situated in the overlap region 10.

### Step A1 and A2:

To prevent printing elements DE (for example of the two print heads 5.1 and 5.2) from generating print dots situated over one another in the overlap region 10, the bitmap is expanded in the rows Z by the number of printing elements DE situated in the overlap region 10; a number of bitmap data columns S corresponding to the number of printing elements DE in the overlap region 10 is thus inserted, or the bitmap is duplicated in the overlap region 10. The printing elements DE of both print heads 5.1, 5.2 in the overlap region 10 may now be offered the same print data per row.

### Steps A3 and A4:

The printing elements DE of either the one print head 5.1 or the other print head 5.2 may now be activated in the overlap region 10 according to a selectable algorithm. For example, the printing elements DE in the overlap region 10 may be activated in alternation. For this, the register locations in the print register 11 may be deleted in alternation or in a duplicated region.

Or, the print data are supplied to the print heads 5 such that the print data are only fed to the respective printing elements DE of a print head 5 in the overlap region 10.

In an exemplary embodiment, possible Moiré effects that might occur given the alternating association of the bitmap data with the print heads 5 may be prevented via use of a random number generator. The print data are then supplied to a respective one of the print heads 5 depending on the result of the random number generator.

Moreover, more complex rasterizing algorithms are also possible that associate the pixel with either the one or the other print head 5 depending on the surrounding pixel data. Given printing elements DE that end in the overlap region 10, for example, the rasterizing algorithm may decide that the printing elements DE of that print head 5 that prints the remaining part of the print image fire print dots. In the example of FIG. 4, the character “e” may then be printed exclusively by printing elements DE1 of the print head 5.1.

Since the tone value increase in print images is strongly nonlinear, an offset of successive print dots of the two print heads 5.1, 5.2 in the sub-pixel range may lead to visible transitions in the print image. Given perfect overprinting by the printing elements DE1 and DE2 of the print heads 5.1 and 5.2, a sub-pixel offset of “0” exists. Assuming this “0” sub-pixel offset, the overlap of the printed dots may decrease by up to half a pixel offset. The local inking thereby decreases. As of an offset of half a pixel, the generation of a print dot should therefore change from a printing element DE1 of the one print head 5.1 to a printing element DE2 of the adjacently situated print head 5.2, for example from the printing element DE12 to the printing element DE23.

In an exemplary embodiment, to remedy this problem of the visible transition in the sub-pixel range, a tone value curve of a reference print image may be determined in the overlap region 10:
The distribution of the pixels and of the bitmap data to the two print heads 5.1, 5.2 using a correction function derived from the tone value curve, which correction function includes the sub-pixel pitch of the print dots of the two print heads 5.1, 5.2 as input variables, may then be specifically corrected.
An inversely proceeding correction function may be determined from the tone value curve, which correction function compensates for the loss of inking. The tone value curve may be stored as a calculation rule or as screening matrices in the print controller 2.
A defined number of rows across which pixels to be printed may be distributed in duplicate may be established using the tone value curve.
A weighting factor may be determined using the tone value curve, which weighting factor allows a defined number of pixels, randomly distributed across the raster rows in the overlap region 10, to be printed by the adjacently situated print heads 5.1 and 5.2 in order to compensate for the loss of inking.
If the print heads 5 provide a multilevel operation, the drop sizes to be fired by the printing elements DE may be adjusted corresponding to the tone value curve.

In an exemplary embodiment, to achieve a somewhat darker inking in the overlap region 10, a proportion of the pixels to be printed by both print heads 5 may be printed simultaneously corresponding to the correction function.

### REFERENCE LIST

DB print image
PF transport direction of the printing substrate web
T_{D} print clock pulse
DE printing element
PR pixel raster
Z row of a pixel raster
S column of a pixel raster
1 ink printing unit
2 printer controller
3 printing substrate web
4.1 to 4.4 print bar
5 ink print head
6 sensor
7 drive roller
8 roll saddle
9 drive roller
10 overlap region
11 print register
12 nozzle side of a print head

What is claimed is:

1. A method to activate printing elements of overlapping print heads arranged offset from one another in an ink printing apparatus, adjacently arranged first and second print heads having an overlap region in which printing elements of the first and the second print heads are situated, the method comprising:
rasterizing, in a printer controller, print images into respective pixel rasters;
developing bitmaps from the pixel rasters, the bitmaps including bitmap data arranged in bitmap data columns and bitmap data rows, wherein a respective bitmap data column is associated with at least one respective printing element of the first and the second print heads;
associating same bitmap data columns of the bitmap with printing elements of the first print head and with printing elements of the second print head, the printing elements of the first print head and the printing elements of the second print head being situated in the overlap region; and
activating the printing elements of the first print head and the printing elements of the second print head in the overlap region such that a print dot associated with a bitmap datum of a bitmap data column of the bitmap data columns is printed by both a first printing element of the printing elements of the first print head and by a second printing element of the printing elements of the second print head.

2. The method according to claim 1, further comprising:
determining a number of the printing elements of the first print head and a number of the printing elements of the second print head that are located in the overlap region;
duplicating the bitmap data columns of the bitmap that are associated with the printing elements of the first print head in the overlap region such that every bitmap datum of the bitmap in the overlap region is associated with the first printing element of the first print head and the second printing element of the of the second print head; and
selectively printing a print dot based on the bitmap datum of the bitmap by one of the first printing element of the first print head and the second printing element of the second print head.

3. The method according to claim 1, further comprising:
determining a number of the printing elements of the first print head and the printing elements of the second print head in the overlap region;
duplicating the bitmap data columns of the bitmap that are associated with the printing elements of the first print head in the overlap region such that each bitmap datum of the bitmap in the overlap region is associated with the first printing element of the first print head and the second printing element of the of the second print head,
respectively printing print dots based on the bitmap datum of the bitmap by only the first printing element of the first print head or the second printing element of the second print head.

4. The method according to claim 2, further comprising:
alternately printing print dots by the first printing element of the first print head and the second printing element of the second print head based on the bitmap datum of the bitmap in the overlap region associated with the first and the second print heads.

5. The method according to claim 2, further comprising:
printing print dots by the first printing element of the first print head and the second printing element of the second print head based on the bitmap datum of the bitmap in the overlap region and a control signal generated by a random number generator, the bitmap datum being associated with the first and the second print heads.

6. The method according to claim 2, further comprising:
printing print dots by the first printing element of the first print head and the second printing element of the second print head based on:
the bitmap datum of the bitmap in the overlap region, the bitmap datum being associated with the first and the second print heads; and
bitmap datum surrounding the overlap region.

7. The method according to claim 2, wherein the printing elements of one of the first print head and the second print head print a remaining part of a print image in the overlap region.

8. The method according to claim 2, further comprising:
determining a tone value curve in the overlap region based on reference print images;
deriving a correction function based on the tone value curve,
activating the printing elements of the first print head and the second print head based on a correction function such that a loss of inking in the overlap region is compensated, the correction function being stored as a calculation rule or as screening matrices in the printer controller.

9. The method according to claim 8, wherein the correction function inversely maps the tone value curve.

10. The method according to claim 8, wherein pixels to the first and the second print heads in the overlap region are distributed based on the correction function derived from the tone value curve, the correction function including a sub-pixel pitch of adjacently situated print dots of the first and the second print heads as an input variable.

11. The method according to claim 8, further comprising:
establishing, based on the tone value curve, a defined number of rows of the bitmap in the overlap region over which the pixels to be printed in duplicate are distributed.

12. The method according to claim 9, further comprising:
establishing, based on the tone value curve, a defined number of rows of the bitmap in the overlap region over which the pixels to be printed in duplicate are distributed.

13. The method according to claim 8, further comprising:
determining a weighting factor based on the tone value curve, wherein the weighting factor allows a defined number of pixels, randomly distributed across the rows of the bitmap in the overlap region, to be printed by the adjacently situated first and second print heads to compensate for the loss of inking.

14. The method according to claim 9, further comprising:
determining a weighting factor based on the tone value curve, wherein the weighting factor allows a defined number of pixels, randomly distributed across the rows of the bitmap in the overlap region, to be printed by the adjacently situated first and second print heads to compensate for the loss of inking.

15. A computer program product embodied on a computer-readable medium comprising program instructions, when executed, causes a processor to perform the method of claim 1.

16. An inkjet printing system configured to perform the method of claim 1.

17. An inkjet printing system comprising the printer controller, the printer controller being configured to perform the method of claim 1.

18. A method to activate printing elements of overlapping first and second print heads of an ink printing apparatus, the first and second print heads having an overlap region in which printing elements of the first and the second print heads are located, the method comprising:
determining bitmaps including bitmap data arranged in bitmap data columns and bitmap data rows, wherein a respective bitmap data column is associated with at least one respective printing element of the first and the second print heads;
associating same bitmap data columns of the bitmap with printing elements of the first print head and with printing elements of the second print head, the printing elements of the first print head and the printing elements of the second print head being situated in the overlap region; and
activating the printing elements of the first print head and the printing elements of the second print head in the overlap region based on the bitmap data such that a print dot is printed by both a first printing element of the printing elements of the first print head and by a second printing element of the printing elements of the second print head.
